(19) United States
(12) Patent Application Publication
(10) Pub. No.: US 2025/0240838 A1
(43) Pub. Date: Jul. 24, 2025

(54) ELECTRONIC DEVICE AND METHOD FOR TRANSMITTING AND/OR RECEIVING DATA ON BASIS OF CONFIGURATION CHANGE IN ELECTRONIC DEVICE

(71) Applicant: Samsung Electronics Co., Ltd., Suwon-si (KR)

(72) Inventors: Wonkyoung JANG, Suwon-si (KR); Doosuk KANG, Suwon-si (KR)

(21) Appl. No.: 19/174,441

(22) Filed: Apr. 9, 2025

Related U.S. Application Data
(63) Continuation of application No. PCT/KR2023/016197, filed on Oct. 18, 2023.

(30) Foreign Application Priority Data
Oct. 18, 2022 (KR) 10-2022-0133904
Dec. 14, 2022 (KR) 10-2022-0175124

(51) Int. Cl. H04W 76/14; H04W 4/80

(52) U.S. Cl. CPC H04W 76/14; H04W 4/80

(57) ABSTRACT

An electronic device may include: memory storing instructions; a communication circuit; and at least one processor operatively connected to the communication circuit and the memory. The instructions that, when executed by the at least one processor individually and/or collectively, may cause the electronic device to transmit and/or receive data to and/or from an external electronic device through a connected isochronous stream (CIS), and may configure CIS configuration information including at least one parameter value that is changed on the basis of the size or format of data to be transmitted and/or received, when it is necessary to change the size of the data to be transmitted and/or received.

### CROSS-REFERENCE TO RELATED APPLICATIONS

This application is a continuation application of International Application No. PCT/KR2023/016197 designating the United States, filed on Oct. 18, 2023, in the Korean Intellectual Property Receiving Office and claiming priority to Korean Patent Application No. 10-2022-0133904, filed on Oct. 18, 2022, and Korean Patent Application No. 10-2022-0175124, filed on Dec. 14, 2022, the disclosures of which are all hereby incorporated by reference herein in their entireties.

### TECHNICAL FIELD

Various example embodiments may relate to a method for an electronic device to transmit and/or receive data to and/or from an external electronic device by using Bluetooth Low Energy (BLE) communication.

### BACKGROUND ART

Low-energy (LE) electronic devices of Bluetooth Core version 5.2 or higher may support LE audio services via a broadcast isochronous stream (BIS) mode or a connected isochronous stream (CIS) mode.

Generally, LE audio services via the BIS or CIS mode are mainly used for video/audio electronic devices accessible by a plurality of users, and are used for audio/video services for a plurality of users for a long time. Recently, the use of LE audio services via the BIS or CIS mode has been gradually expanding in TVs or mobile electronic devices to simultaneously provide audio services for a small group of users rather than a number of unspecified users.

However, the need to dynamically change a configuration for the BIS or CIS mode is emerging when the size of data to be transmitted or received is changed while an electronic device forwards audio data to another electronic device via an LE audio service.

### SUMMARY

According to an example embodiment, an electronic device may include memory storing instructions, a communication circuit, and at least one processor, comprising processing circuitry, operatively connected, directly or indirectly, to the communication circuit and the memory. The instructions that, when executed by the at least one processor individually and/or collectively may cause the electronic device to configure CIS configuration information including at least one parameter value changed based on a size or format of data to be transmitted and/or received when the electronic device is configured to transmit and/or receive the data to and/or from an external electronic device through a connected isochronous stream (CIS) and the size or format of the data to be transmitted and/or received needs to be changed. The instructions that, when executed by the at least one processor individually and/or collectively may cause the electronic device to transmit the CIS configuration information including the at least one parameter value to the external electronic device through the communication circuit. The instructions that, when executed by the at least one processor individually and/or collectively may cause the electronic device to receive a response message from the external electronic device in response to the CIS configuration information through the communication circuit. The instructions that, when executed by the at least one processor individually and/or collectively may cause the electronic device to transmit and/or receive the data to and/or from the external electronic device, based on the CIS configuration information.

According to an example embodiment, an electronic device may include memory storing instructions, a communication circuit, and at least one processor operatively connected, directly or indirectly, to the communication circuit and the memory. The instructions that, when executed by the at least one processor individually and/or collectively may cause the electronic device to receive CIS configuration information including at least one parameter value changed based on a size or format of data to be transmitted and/or received from through the communication circuit when the electronic device is configured to transmit and/or receive data to and/or from an external electronic device through a connected isochronous stream (CIS). The instructions that, when executed by the at least one processor individually and/or collectively may cause the electronic device to transmit a response message to the external electronic device in response to the CIS configuration information through the communication circuit. The instructions that, when executed by the at least one processor individually and/or collectively may cause the electronic device to transmit and/or receive the data to and/or from the external electronic device, based on the CIS configuration information.

According to an example embodiment, a method of an electronic device may include configuring CIS configuration information including at least one parameter value changed based on a size or format of the data to be transmitted and/or received when the electronic device is configured to transmit and/or receive data to and/or from an external electronic device through a connected isochronous stream (CIS) and the size or format of the data to be transmitted and/or received needs to be changed. The method of the electronic device may include transmitting the CIS configuration information including the at least one parameter value to the external electronic device. The method of the electronic device may include receiving a response message from the external electronic device in response to the CIS configuration information. The method of the electronic device may include transmitting and/or receiving the data to and/or from the external electronic device, based on the CIS configuration information.

According to an example embodiment, a method of an electronic device may include receiving CIS configuration information including at least one parameter value changed based on a size or format of data to be transmitted and/or received from an external electronic device when the electronic device is configured to transmit and/or receive data to and/or from the external electronic device through a connected isochronous stream (CIS). The method of the electronic device may include transmitting a response message to the external electronic device in response to the CIS configuration information. The method of the electronic device may include transmitting and/or receiving the data to and/or from the external electronic device, based on the CIS configuration information.

According to an example embodiment, there may be provided a storage medium storing at least one computer-readable instruction. The at least one instruction may, when executed by the at least one processor individually and/or collectively, cause an electronic device to perform a plurality of operations. The plurality of operations may include configuring CIS configuration information including at least one parameter value changed based on a size or format of the data to be transmitted and/or received when the electronic device is configured to transmit and/or receive data to and/or from an external electronic device through a connected isochronous stream (CIS) and the size or format of the data to be transmitted and/or received needs to be changed. The plurality of operations may include transmitting the CIS configuration information including the at least one parameter value to the external electronic device. The plurality of operations may include receiving a response message from the external electronic device in response to the CIS configuration information. The plurality of operations may include transmitting and/or receiving the data to and/or from the external electronic device, based on the CIS configuration information.

According to an example embodiment, there may be provided a storage medium storing at least one computer-readable instruction. The at least one instruction may, when executed by the at least one processor individually and/or collectively, cause an electronic device to perform a plurality of operations. The plurality of operations may include receiving CIS configuration information including at least one parameter value changed based on a size or format of data to be transmitted and/or received from an external electronic device when the electronic device is configured to transmit and/or receive data to and/or from the external electronic device through a connected isochronous stream (CIS). The plurality of operations may include transmitting a response message to the external electronic device in response to the CIS configuration information. The plurality of operations may include transmitting and/or receiving the data to and/or from the external electronic device, based on the CIS configuration information.

### BRIEF DESCRIPTION OF DRAWINGS

FIG. 1 is a block diagram schematically illustrating an electronic device in a network environment according to an example embodiment;

FIG. 2 is a block diagram of an audio module according to an example embodiment;

FIG. 3 illustrates an example of operations of a plurality of electronic devices according to an example embodiment;

FIG. 4 illustrates an example of a CIS event including two consecutive CIS subevents according to an example embodiment;

FIG. 5 illustrates an example of a CIS event according to an example embodiment;

FIG. 6 illustrates an example of transmitting and/or receiving a packet between an electronic device and an external electronic device in a plurality of CIS events according to an example embodiment;

FIG. 7 illustrates a BIG event and a BIS event according to an example embodiment;

FIG. 8A illustrates an example of BISs in a sequential arrangement according to an example embodiment;

FIG. 8B illustrates an example of BISs in an interleaved arrangement according to an example embodiment;

FIG. 9 is a flowchart illustrating an operating method of an electronic device requesting a configuration change according to an example embodiment;

FIG. 10 is a flowchart illustrating an operating method of an electronic device receiving a configuration change request according to an example embodiment;

FIG. 11 illustrates an example of transmitting and/or receiving a packet between an electronic device and an external electronic device in a plurality of CIS events according to an example embodiment;

FIG. 12 illustrates another example of transmitting and/or receiving a packet between an electronic device and an external electronic device in a plurality of CIS events according to an example embodiment;

FIG. 13 illustrates still another example of transmitting and/or receiving a packet between an electronic device and an external electronic device in a plurality of CIS events according to an example embodiment; and

FIG. 14 is a flowchart illustrating an operating method of an electronic device according to an example embodiment.

### DETAILED DESCRIPTION

Hereinafter, an embodiment of the disclosure will be described in detail with reference to the accompanying drawings. Furthermore, in describing an embodiment of the disclosure, a detailed description of known functions or configurations incorporated herein will be omitted when it is determined that the description may make the subject matter of the embodiment of the disclosure unnecessarily unclear. The terms which will be described below are terms defined in consideration of the functions in an embodiment of the disclosure, and may be different according to users, intentions of the users, or customs. Therefore, the definitions of the terms should be made based on the contents throughout the specification.

It should be noted that the technical terms used herein are only used to describe specific embodiments, and are not intended to limit an embodiment of the disclosure. Alternatively, the technical terms used herein should be interpreted to have the same meaning as those commonly understood by a person skilled in the art to which the disclosure pertains, and should not be interpreted have excessively comprehensive or excessively restricted meanings unless particularly defined as other meanings. Alternatively, when the technical terms used herein are wrong technical terms that cannot correctly represent the idea of the disclosure, it should be appreciated that they are replaced by technical terms correctly understood by those skilled in the art. Alternatively, the general terms used herein should be interpreted as defined in dictionaries or interpreted in the context of the relevant part, and should not be interpreted to have excessively restricted meanings.

Alternatively, a singular expression used herein may include a plural expression unless they are definitely different in the context. As used herein, such an expression as “comprises” or “include” should not be interpreted to necessarily include all elements or all steps described in the specification, and should be interpreted to be allowed to exclude some of them or further include additional elements or steps.

Alternatively, the terms including an ordinal number, such as expressions “a first” and “a second” may be used to described various elements, but the corresponding elements should not be limited by such terms. The above terms are used merely for the purpose of distinguishing one element from other elements. For example, a first element may be termed a second element, and similarly, a second element may be termed a first element without departing from the scope of protection of the disclosure.

It should be understood that when an element is referred to as being “connected” or “coupled” to another element, it may be connected or coupled directly to the other element, or any other element may be interposer between them. Contrarily, in the case where an element is referred to as being “directly connected” or “directly coupled” to any other element, it should be understood that no other element exists therebetween. Thus, “connected” as used herein covers both direct and indirect connections.

Hereinafter, an embodiment according to the disclosure will be described in detail with reference to the accompanying drawings, and the same or similar elements are given the same and similar reference numerals, regardless of drawing signs, so duplicate descriptions thereof will be omitted. Alternatively, in describing an embodiment of the disclosure, a detailed description of known functions or configurations incorporated herein will be omitted when it is determined that the description may make the subject matter of the disclosure unnecessarily unclear. Alternatively, it should be noted that the accompanying drawings are presented merely to help easy understanding of the disclosure, and are not intended to limit the disclosure. The technical idea of the disclosure should be construed to cover all changes, equivalents, and alternatives, in addition to the drawings.

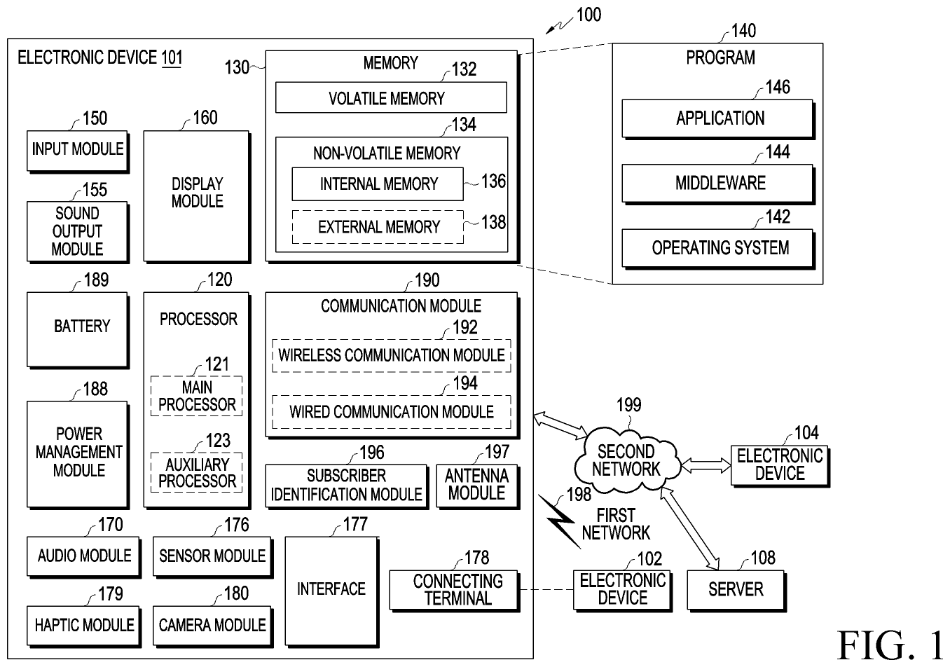

FIG. 1 is a block diagram schematically illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to an embodiment may be one of various types of electronic devices. The electronic devices may include, for example, a portable communication device (e.g., a smartphone), a computer device, a portable multimedia device, a portable medical device, a camera, a wearable device, a home appliance, or wireless earphone, ear buds. According to an embodiment of the disclosure, the electronic devices are not limited to those described above.

It should be appreciated that an embodiment of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element. Thus, “connected” as used herein covers both direct and indirect connections.

As used in connection with an embodiment of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

An embodiment as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

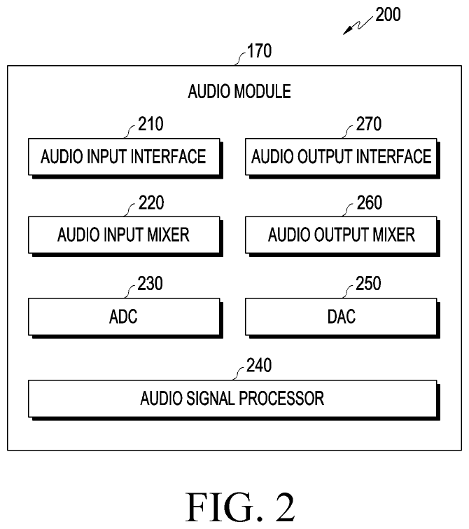

FIG. 2 is a block diagram 200 illustrating the audio module 170 according to various embodiments. Referring to FIG. 2, the audio module 170 may include, for example, an audio input interface 210, an audio input mixer 220, an analog-to-digital converter (ADC) 230, an audio signal processor 240, a digital-to-analog converter (DAC) 250, an audio output mixer 260, or an audio output interface 270.

The audio input interface 210 may receive an audio signal corresponding to a sound obtained from the outside of the electronic device 101 via a microphone (e.g., a dynamic microphone, a condenser microphone, or a piezo microphone) that is configured as part of the input device 150 or separately from the electronic device 101. For example, if an audio signal is obtained from the external electronic device 102 (e.g., a headset or a microphone), the audio input interface 210 may be connected with the external electronic device 102 directly via the connecting terminal 178, or wirelessly (e.g., Bluetooth™ communication) via the wireless communication module 192 to receive the audio signal. According to an embodiment, the audio input interface 210 may receive a control signal (e.g., a volume adjustment signal received via an input button) related to the audio signal obtained from the external electronic device 102. The audio input interface 210 may include a plurality of audio input channels and may receive a different audio signal via a corresponding one of the plurality of audio input channels, respectively. According to an embodiment, additionally or alternatively, the audio input interface 210 may receive an audio signal from another component (e.g., the processor 120 or the memory 130) of the electronic device 101.

The audio input mixer 220 may synthesize a plurality of inputted audio signals into at least one audio signal. For example, according to an embodiment, the audio input mixer 220 may synthesize a plurality of analog audio signals inputted via the audio input interface 210 into at least one analog audio signal.

The ADC 230 may convert an analog audio signal into a digital audio signal. For example, according to an embodiment, the ADC 230 may convert an analog audio signal received via the audio input interface 210 or, additionally or alternatively, an analog audio signal synthesized via the audio input mixer 220 into a digital audio signal.

The audio signal processor 240 may perform various processing on a digital audio signal received via the ADC 230 or a digital audio signal received from another component of the electronic device 101. For example, according to an embodiment, the audio signal processor 240 may perform changing a sampling rate, applying one or more filters, interpolation processing, amplifying or attenuating a whole or partial frequency bandwidth, noise processing (e.g., attenuating noise or echoes), changing channels (e.g., switching between mono and stereo), mixing, or extracting a specified signal for one or more digital audio signals. According to an embodiment, one or more functions of the audio signal processor 240 may be implemented in the form of an equalizer.

The DAC 250 may convert a digital audio signal into an analog audio signal. For example, according to an embodiment, the DAC 250 may convert a digital audio signal processed by the audio signal processor 240 or a digital audio signal obtained from another component (e.g., the processor (120) or the memory (l30)) of the electronic device 101 into an analog audio signal.

The audio output mixer 260 may synthesize a plurality of audio signals, which are to be outputted, into at least one audio signal. For example, according to an embodiment, the audio output mixer 260 may synthesize an analog audio signal converted by the DAC 250 and another analog audio signal (e.g., an analog audio signal received via the audio input interface 210) into at least one analog audio signal.

The audio output interface 270 may output an analog audio signal converted by the DAC 250 or, additionally or alternatively, an analog audio signal synthesized by the audio output mixer 260 to the outside of the electronic device 101 via the sound output device 155. The sound output device 155 may include, for example, a speaker, such as a dynamic driver or a balanced armature driver, or a receiver. According to an embodiment, the sound output device 155 may include a plurality of speakers. In such a case, the audio output interface 270 may output audio signals having a plurality of different channels (e.g., stereo channels or 5.1 channels) via at least some of the plurality of speakers. According to an embodiment, the audio output interface 270 may be connected with the external electronic device 102 (e.g., an external speaker or a headset) directly via the connecting terminal 178 or wirelessly via the wireless communication module 192 to output an audio signal.

According to an embodiment, the audio module 170 may generate, without separately including the audio input mixer 220 or the audio output mixer 260, at least one digital audio signal by synthesizing a plurality of digital audio signals using at least one function of the audio signal processor 240.

According to an embodiment, the audio module 170 may include an audio amplifier (not shown) (e.g., a speaker amplifying circuit) that is capable of amplifying an analog audio signal inputted via the audio input interface 210 or an audio signal that is to be outputted via the audio output interface 270. According to an embodiment, the audio amplifier may be configured as a module separate from the audio module 170.

Various embodiments of the disclosure relate to a method in which an electronic device transmits and/or receives audio data to and/or from an external electronic device by using Bluetooth Low Energy (or BLE) communication, and electronic devices of Bluetooth Core version 5.2 or higher may support an audio service via a connected isochronous stream (CIS) mode or a broadcast isochronous stream (BIS) mode.

When supporting an audio service via a CIS mode, an electronic device may establish a CIS link for transmitting audio data to an external electronic device by using BLE communication, and configurations at a time of establishing the CIS link are fixed until the CIS link is disconnected. When supporting an audio service via a BIS mode, an electronic device may broadcast audio data for an external electronic device without establishing a communication link with the external electronic device.

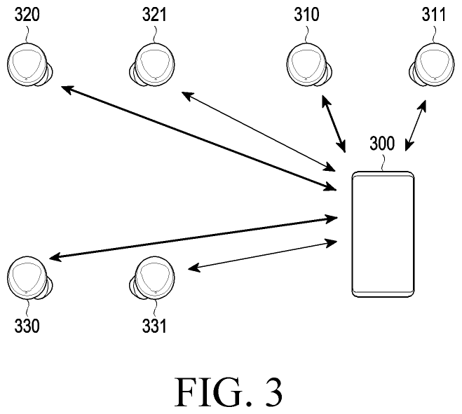

FIG. 3 illustrates an example of operations of a plurality of electronic devices according to an embodiment.

Referring to FIG. 3, a first electronic device 300 (e.g., the electronic device 101 of FIG. 1) may be configured as a portable communication device (e.g., a smartphone), a second electronic device 310 and 311 may be configured as a pair of wireless earphones worn respectively on a user's left and right ears, a third electronic device 320 and 321 may be configured as a pair of wireless earphones worn respectively on the user's left and right ears, and a fourth electronic device 330 and 331 may be configured as a pair of wireless earphones worn respectively on the user's left and right ears. According to an embodiment, the first electronic device 300 may transmit and/or receive a signal and/or data to and/or from the second electronic device 310 and 311. According to an embodiment, the first electronic device 300 may transmit and/or receive a signal and/or data to and/or from the third electronic device 320 and 321. According to an embodiment, the first electronic device 300 may transmit and/or receive a signal and/or data to and/or from the fourth electronic device 330 and 331.

When supporting an audio service via a CIS mode, the first electronic device 300 may recognize at least one of the second electronic device 310 and 311, the third electronic device 320 and 321, and the fourth electronic device 330 and 331 by using wireless communication (e.g., BLE communication). At least one of the second electronic device 310 and 311, the third electronic device 320 and 321, and the fourth electronic device 330 and 331 may transmit an advertising signal in a broadcast mode. When receiving the advertising signal, the first electronic device 300 may establish a communication link with the at least one of the second electronic device 310 and 311, the third electronic device 320 and 321, and the fourth electronic device 330 and 331 by using information included in the advertising signal. The at least one of the second electronic device 310 and 311, the third electronic device 320 and 321, and the fourth electronic device 330 and 331 may receive audio data from the first electronic device 300 by using the established communication link.

When supporting an audio service via a BIS mode, the first electronic device 300 may broadcast audio data in the BIS mode, and at least one of the second electronic device 310 and 311, the third electronic device 320 and 321, and the fourth electronic device 330 and 331 may receive the audio data broadcast from the first electronic device 300. The first electronic device 300 may broadcast configuration information necessary for other electronic devices to receive the audio data. At least one of the second electronic device 310 and 311, the third electronic device 320 and 321, and the fourth electronic device 330 and 331 may receive audio data from the first electronic device 300, based on the configuration information broadcast from the first electronic device 300.

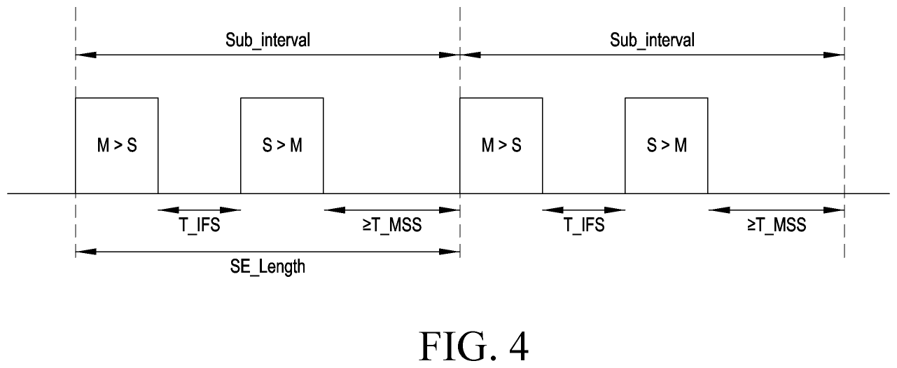

FIG. 4 illustrates an example of a CIS event including two consecutive CIS subevents according to an embodiment.

A CIS refers to a logical transport that enables an electronic device (e.g., the electronic device 101 of FIG. 1 or the electronic device 300 of FIG. 3) connected to an external electronic device (e.g., the electronic device 102 or the electronic device 104 of FIG. 1, or the second electronic device 310 and 311, the third electronic device 320 and 321, or the fourth electronic device 330 and 331 of FIG. 3) to transmit isochronous data in one direction and/or two directions. Isochronous data may be transmitted in an LE-S or LE-F logical link by using a CIS logical transport, and each CIS may be connected with an LE asynchronous connection (LE ACL). The CIS may support a variable-size packet and/or transmission of one or more packets in each CIS event.

Referring to FIG. 4, a CIS event may include two CIS subevents of Sub_Interval. Sub_Interval refers to an interval between consecutive subevents in a CIS event. Time duration allocated to each CIS subevent may also be referred to as SE_Length, and Sub_Interval and SE_Length may be the same value. According to an embodiment, Sub_Interval may be a preset time duration, and each Sub_Interval may include the same time slot. According to an embodiment, Sub_Interval may be a variable time duration, and each Sub_Interval may include a variable time slot.

In a subevent within the CIS event, the electronic device (e.g., the electronic device 101 of FIG. 1 or the electronic device 300 of FIG. 3) may transmit a first packet (M>S) to the external electronic device (e.g., the electronic device 102 or the electronic device 104 of FIG. 1, or the second electronic device 310 and 311, the third electronic device 320 and 321, or the fourth electronic device 330 and 331 of FIG. 3), and the external electronic device may transmit a second packet (S>M) to the electronic device. The electronic device may serve as a role of a master device in CIS-based communication, and the external electronic device may serve as a role of a slave device in CIS-based communication. “M>S” in the packet refers to the direction of the packet transmitted from the master device to the slave device, and “S<M” in the packet refers to the direction of the packet transmitted from the slave device to the master device.

A time interval between the first packet (M>S) and the second packet (S>M) transmitted in the CIS subevent may be a T_IFS (inter frame space), and a time interval between the last packet (S>M) in a CIS subevent and the initial packet (M>S) transmitted in the next CIS subevent may be configured to be equal to or greater than T_MSS (minimum subevent space). According to an embodiment, a minimum time interval between packets transmitted in one CIS subevent may be configured to T_IFS, and a minimum time interval between the last packet in the current CIS subevent and the initial packet transmitted in the next CIS subevent may be configured to T_MSS.

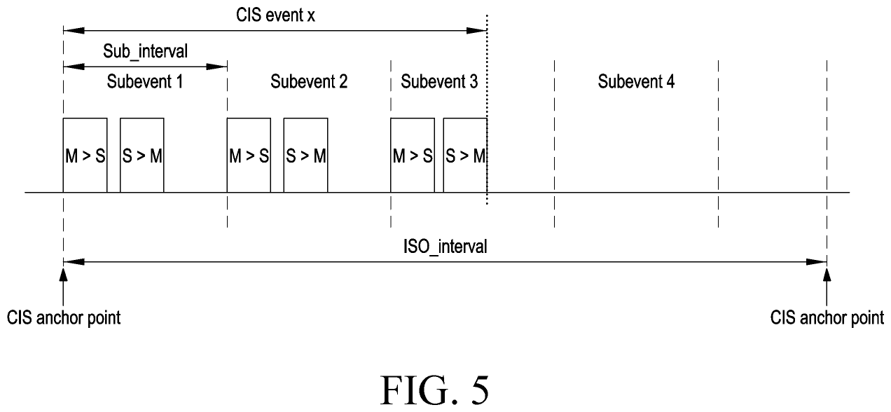

FIG. 5 illustrates an example of a CIS event according to an embodiment. Referring to FIG. 5, CIS event x in ISO_Interval may have NSE=4 (Subevent1˜4), and may include three subevents (Subevents 1 to 3) in which a packet is actually transmitted. NSE is the number of subevents per CIS in each CIS event. ISO_Interval is a time interval between CIS anchor points (or time between adjacent CIS anchor points).

In the subevents (Subevents 1 to 3) in CIS event x, an electronic device may transmit an “M>S” packet to an external electronic device, and the external electronic device (e.g., the electronic device 102 or the electronic device 104 of FIG. 1, or the second electronic device 310 and 311, the third electronic device 320 and 321, or the fourth electronic device 330 and 331 of FIG. 3) may transmit an “S>M” packet to the electronic (e.g., the electronic device 101 of FIG. 1 or the electronic device 300 of FIG. 3). The electronic device may serve as a role of a master device in CIS-based communication, and the external electronic device may serve as a role of a slave device in CIS-based communication. “M>S” in the packet refers to the direction of the packet transmitted from the master device to the slave device, and “S<M” in the packet refers to the direction of the packet transmitted from the slave device to the master device.

In a first subevent (Subevent 1), a 1-1 packet (M>S) and a 1-2 packet (S>M) may be transmitted. According to an embodiment, time duration occupied by the 1-1 packet (M>S) in the first subevent (Subevent 1) may be configured to be the same as time duration occupied by the 1-2 packet (S>M). According to an embodiment, the time duration occupied by the 1-1 packet (M>S) in the first subevent (Subevent 1) may be configured to different from the time duration occupied by the 1-2 packet (S>M).

In a second subevent (Subevent 2), a 2-1 packet (M>S) and a 2-2 packet (S>M) may be transmitted. According to an embodiment, time duration occupied by the 2-1 packet (M>S) in the second subevent (Subevent 2) may be configured to be the same as time duration occupied by the 2-2 packet (S>M). According to an embodiment, the time duration occupied by the 2-1 packet (M>S) in the second subevent (Subevent 2) may be configured to be different from the time duration occupied by the 2-2 packet (S>M).

In a third subevent (Subevent 3), a 3-1 packet (M>S) and a 3-2 packet (S>M) may be transmitted. According to an embodiment, time duration occupied by the 3-1 packet (M>S) in the third subevent (Subevent 3) may be configured to be the same as time duration occupied by the 3-2 packet (S>M). According to an embodiment, the time duration occupied by the 3-1 packet (M>S) in the third subevent (Subevent 3) may be configured to be different from the time duration occupied by the 3-2 packet (S>M).

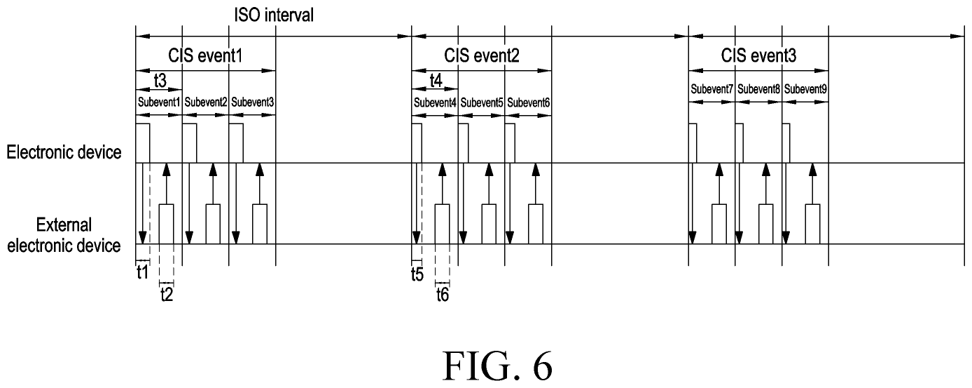

FIG. 6 illustrates an example of transmitting and/or receiving a packet between an electronic device and an external electronic device in a plurality of CIS events according to an embodiment.

In subevents in a CIS event, the electronic device may serve as a role of a master device in CIS-based communication, and the external electronic device may serve as a role of a slave device in CIS-based communication.

Referring to FIG. 6, a first CIS event (CIS event 1) within an ISO interval may include a first subevent (subevent 1), a second subevent (subevent 2), and a third subevent (subevent 3). In the first subevent (subevent 1), the electronic device (e.g., the electronic device 101 of FIG. 1 or the electronic device 300 of FIG. 3) may transmit a 1-1 packet to the external electronic device (e.g., the electronic device 102 or the electronic device 104 of FIG. 1, or the second electronic device 310 and 311, the third electronic device 320 and 321, or the fourth electronic device 330 and 331 of FIG. 3), and the external electronic device may transmit a 1-2 packet to the electronic device. According to an embodiment, first time duration (t1) occupied by the packet transmitted from the electronic device to the external electronic device in time duration (t3) occupied by the first subevent (subevent 1) may be configured to be the same as second time duration (t2) occupied by the packet transmitted from the external electronic device to the electronic device. In a second subevent (subevent 2), the electronic device may transmit a 2-1 packet to the external electronic device, and the external electronic device may transmit a 2-2 packet to the electronic device. In the third subevent (subevent 3), the electronic device may transmit a 3-1 packet to the external electronic device, and the external electronic device may transmit a 3-2 packet to the electronic device.

A second CIS event within the ISO interval may include a fourth subevent (subevent 4), a fifth subevent (subevent 5), and a sixth subevent (subevent 6). In the fourth subevent (subevent 4), the electronic device may transmit a 4-1 packet to the external electronic device, and the external electronic device may transmit a 4-2 packet to the electronic device. According to an embodiment, third time duration (t5) occupied by the packet transmitted from the electronic device to the external electronic device in time duration (t4) occupied by the fourth subevent (subevent 4) may be configured to be shorter than fourth time duration (t6) occupied by the packet transmitted from the external electronic device to the electronic device. In the fifth subevent (subevent 5), the electronic device may transmit a 5-1 packet to the external electronic device, and the external electronic device may transmit a 5-2 packet to the electronic device. In the sixth subevent (subevent 6), the electronic device may transmit a 6-1 packet to the external electronic device, and the external electronic device may transmit a 6-2 packet to the electronic device. According to an embodiment, the third time duration (t5) occupied by the packet transmitted from the electronic device to the external electronic device in the second CIS event may be configured to be shorter than the first time duration (t1) occupied by the packet transmitted from the electronic device to the external electronic device in the first CIS event.

A third CIS event within the ISO interval may include a seventh subevent (subevent 7), an eighth subevent (subevent 8), and a ninth subevent (subevent 9). In the seventh subevent (subevent 7), the electronic device may transmit a 7-1 packet to the external electronic device, and the external electronic device may transmit a 7-2 packet to the electronic device. In the eighth subevent (subevent 8), the electronic device may transmit an 8-1 packet to the external electronic device, and the external electronic device may transmit an 8-2 packet to the electronic device. In the 9th subevent (subevent 9), the electronic device may transmit a 9-1 packet to the external electronic device, and the external electronic device may transmit a 9-2 packet to the electronic device.

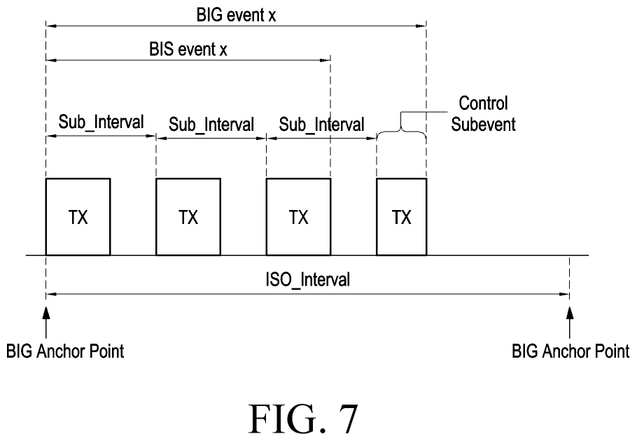

FIG. 7 illustrates a BIG event and a BIS event according to an embodiment.

A broadcast mode enables data to be streamed from a single source (or source electronic device) to a plurality of sinks (or sink electronic devices) by using a group of synchronized streams. Each stream used in the broadcast mode may be referred to as a BIS, and a group of BISs may be referred to as a broadcast isochronous group (BIG).

A BIS logical transport is used to transmit one or more isochronous data streams to all devices for a BIS within a range. A BIS may include one or more subevents for transmitting isochronous data packets. A BIS supports transmission of a plurality of isochronous data packets in all BIS events.

Referring to FIG. 7, BIG event x may include BIS event x, and specific isochronous data may be transmitted within BIS event x. ISO_Interval refers to time between two adjacent BIG anchor points, and Sub_Interval refers to time between the starts of two consecutive subevents of each BIS. According to an embodiment, BIG event x may include at least one BIS event x, and BIS event x may include at least one subevent.

A BIS event may include one or more BIS PDUs. A link layer transmits a BIS PDU only in a BIG event. The link layer transmits only a BIS PDU as a part of a BIG event. Each BIG event is divided into BIS events divided by Num_BIS and a control subevent. Each BIS event is divided into NSE subevents. Each BIS event starts at a moment called a BIS anchor point, and ends after the last subevent. Each BIG event starts at a moment called a BIG anchor point, and ends after a control subevent if present or ends at the last constituent BIS event otherwise. BIG anchor points need be regularly spaced at intervals of ISO_Interval. BIS anchor points for BIS n of a BIG need to be (n−1)*BIS_Spacing after a BIG anchor point, and are regularly spaced at intervals of ISO_Interval. Subevents of each BIS need be spaced by Sub_Interval. An isochronous broadcaster needs to terminate a BIG event at least T_IFS before the BIG anchor point of the next BIG event.

A BIS has no acknowledgment protocol, and traffic may be unidirectionally transmitted from a broadcasting device. A BIS logical transport has no acknowledgment, and an isochronous data packet may be retransmitted by increasing the number of subevents in each event to improve transmission reliability.

A BIS supports LE-S or LE-F logical links, and also supports low energy broadcast control (LEB-C) logical links. A BIS may be identified by unique access address and timing information. The access address and timing information may be transmitted in a packet transmitted using an associated periodic advertising broadcast (PADVB) logical transport. A scanning device supporting a synchronized receiver role may synchronize with a BIS by using timing information from a periodic advertising train, and may then receive isochronous data within the BIS.

Each BIS is a part of a BIG, and a BIG may include one or more BISs. A plurality of BISs within a BIG has a common timing reference, based on a broadcaster, and synchronizes in time. For example, left and right channels of an audio stereo stream received by a separate device need to be rendered simultaneously. A plurality of BISs within a BIG may be scheduled sequentially or in an interleaved arrangement.

For an electronic device to receive a BIS, the link layer needs to obtain BIG information (BIGInfo) describing streams. BIG information (BIGInfo) may be obtained from additional controller advertising data (ACAD) of periodic advertising. Each BIG may be provided with the following parameters.
Num_BIS is the number of BISs within the BIG. The BISs in the BIG may be assigned different BIS_Numbers from 1 to Num_BIS.
ISO_Interval is time (e.g., 1.25 ms) between two adjacent BIG anchor points. For example, ISO_Interval may range from 4 to 3200 (5 ms to 4 s).
BIS_Spacing is time between the start of a corresponding subevent in adjacent BISs in the BIG and the start of the initial subevent of the last BIS and a control subevent.
Sub_Interval is time between the starts of two consecutive subevents in each BIS.
Max_PDU is the maximum number of data octets (excluding an MIC) that can be transmitted in each BIS data PDU in the BIG. For example, the value of Max_PDU ranges from 1 to 251.
Max_SDU is the maximum size of a SDU of the BIG. For example, the value of Max_SDU ranges from 1 to 4095.
MTP need to be equal to time taken to transmit a packet including a BIS data PDU along with a payload of a Max_PDU octet in a PHY used for a BIS, and S=8 is assumed for an LE coded PHY.
BN, PTO, and IRC control what data is transmitted in each BIG event. The value of BN needs to range from 1 to 7. The value of PTO needs to range from 0 to 15. The value of IRC needs to range from 1 to 15.
NSE is the number of subevents per BIS in each BIG event. This value needs to range from 1 to 31, and needs to be an integer multiple of BN.
Framed indicates whether the BIG carries framed data or unframed data.
Encrypted indicates whether the BIG is encrypted.

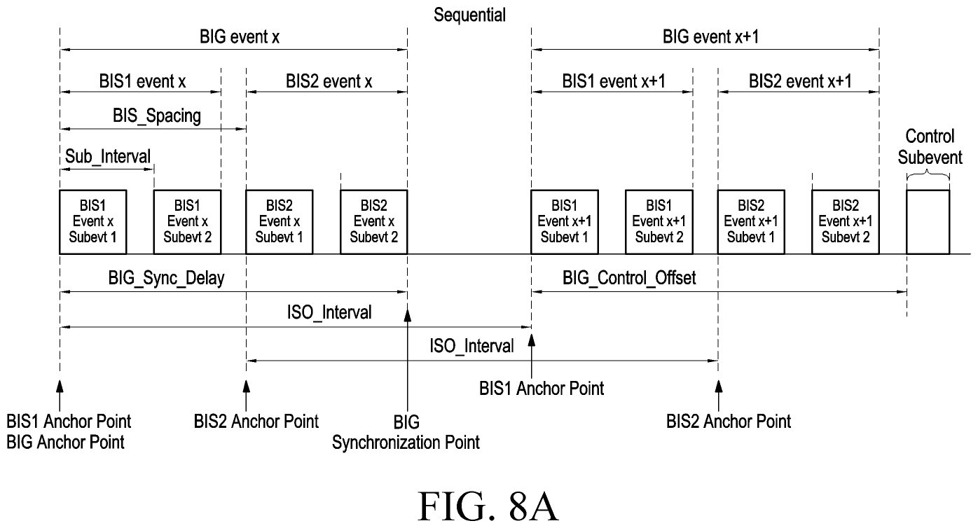

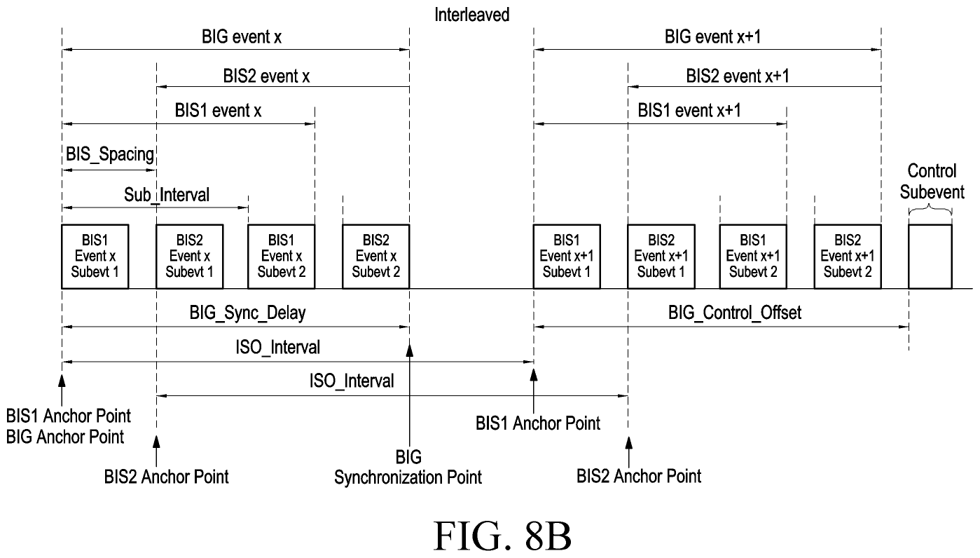

FIG. 8A illustrates an example of BISs in a sequential arrangement according to an embodiment, and FIG. 8B illustrates an example of BISs in an interleaved arrangement according to an embodiment.

BISs in a BIG may be arranged to be sequential or interleaved by suitably configuring the values of Sub_Interval and BIS_Spacing parameters. BIS subevents are occasions for an isochronous broadcaster to transmit a broadcaster isochronous BIS PDU and for a synchronized receiver to receive the same.

FIG. 8A illustrates a sequential arrangement of a BIG with Num_BIS=2 and NSE=2. BIG event x may sequentially include BIS1 event x and BIS2 event x, BIS1 event x may include BIS1 Event x Subevt 1 and BIS1 Event x Subevt 2, and BIS2 event x may include BIS2 Event x Subevt 1 and BIS2 Event x Subevt 2. According to an embodiment, in the sequential arrangement, since BIS_Spacing needs to be NSE*Sub_Interval or greater, all subevents of the BIS events may occur together.

FIG. 8B illustrates an interleaved arrangement of a BIG with Num_BIS=2 and NSE=2. BIG event x may include BIS1 event x and BIS2 event x which are interleaved. BIG event x may include BIS1 Event x Subevt 1, BIS2 Event x Subevt 1, BIS1 Event x Subevt 2, BIS2 Event x Subevt 2 in chronological order. According to an embodiment, in the interleaved arrangement, Sub_Interval needs to be Num_BIS*BIS_Spacing, the initial subevents of all BISs are adjacent, and the second subevents of all BIS are adjacent. In each case, the minimum value of BIS_Spacing may be used.

Referring to FIG. 8A and FIG. 8B, the maximum length possible for a data part of a BIG event (excluding a control subevent) is denoted by BIG_Sync_Delay. The value of BIG_Sync_Delay may be equal to time from an anchor point to a BIG synchronization, which is the end of a packet including a payload of a Max_PDU octet transmitted in the last subevent.

Various embodiments of the disclosure may propose a method for efficiently changing a CIS configuration when the size of audio data transmitted or received changes while an electronic device generates a CIS link with an external electronic device and transmits and/or receives data (or audio data). Even though the size of the data transmitted or received after the CIS link is generated is dynamically changed, Sub_Interval remains the same, and thus the data may occupy the same timeslot. In various embodiments of the disclosure, data (or audio data) may be efficiently transmitted and/or received by changing a CIS configuration (e.g., subevent length (SE_Length), subevent interval (Sub_Interval), and/or the number of subevents (NSE)), based on the size of the data (or audio data).

Embodiments of the disclosure relate to a technology for an electronic device to transmit and/or receive data by changing at least one parameter value according to a change in the size or format of data to be transmitted and/or received and considering the changed at least one parameter value when the electronic device is configured to transmit and/or receive the data to and/or from an external electronic device via a CIS or a BIS described in FIG. 4 to FIG. 8B.

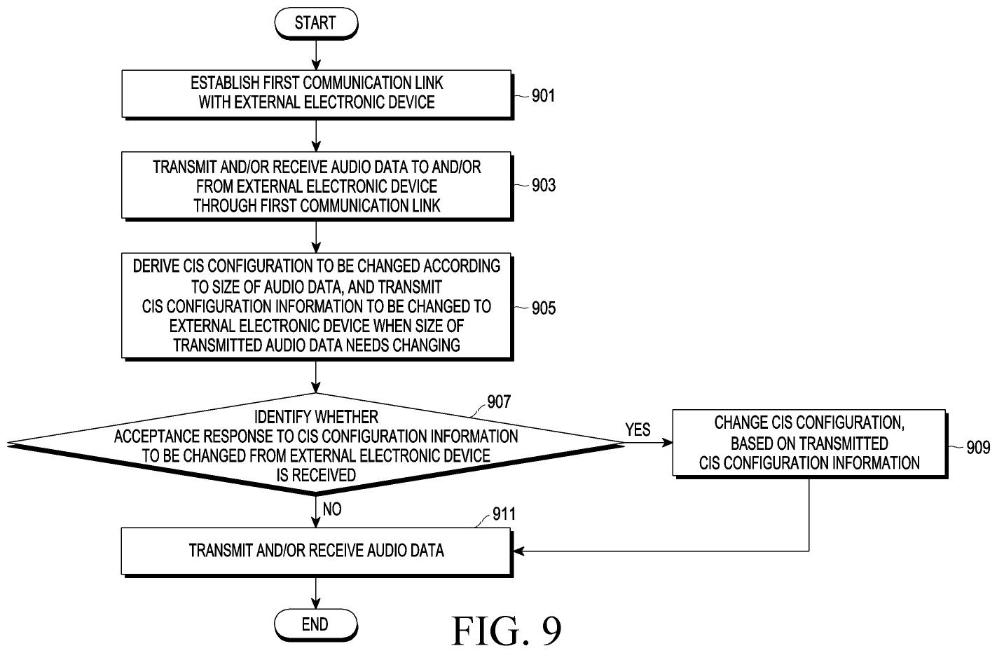

FIG. 9 is a flowchart illustrating an operating method of an electronic device requesting a configuration change according to an embodiment of the disclosure.

In FIG. 9, the electronic device may transmit and/or receive audio data to and/or from an external electronic device via a CIS mode, and may request a CIS configuration change from the external electronic device. For example, the electronic device may be configured as a mobile phone, and the external electronic device may be configured as a wireless earphone. In an embodiment, at least one of operation 901 to operation 911 may be omitted, some of the operations may be performed in a different order, or other operations may be added.

In operation 901, the electronic device may establish a first communication link (or CIS link) with the external electronic device. The electronic device may recognize the external electronic device by using wireless communication (e.g., BLE communication). The external electronic device may perimetrically generate an advertising signal in a broadcast mode. According to an embodiment, the external electronic device may generate the advertising signal according to a specified condition. For example, the external electronic device may output the advertising signal, based on at least one of power supply, a specified time period, and a user input.

According to an embodiment, the advertising signal may be a signal (e.g., pairing) transmitting information related to connection or an account to an unspecified surrounding electronic device by using wireless communication (e.g., BLE communication). According to an embodiment, the advertising signal may include at least one of identification information about the external electronic device, account information about a user, information about whether the external electronic device is currently paired with another device (hereinafter, current pairing information), a list of previously paired devices (hereinafter, a pairing list), information about devices that are simultaneously pairable (hereinafter, simultaneous pairing information), TX power of the external electronic device, and/or information about the battery level of the external electronic device (hereinafter, battery state information).

When receiving the advertising signal, the electronic device may output a user interface for connection with the external electronic device through a display. The electronic device may output a user interface according to various conditions, based on the information included in the advertising signal. For example, the electronic device receiving the advertising signal from the external electronic device may output a user interface including an image corresponding to the external electronic device. The electronic device may establish the first communication link with the external electronic device by using the information included in the received advertising signal.

According to an embodiment, the external electronic device may include a primary earphone and a secondary earphone which are physically separate, and the primary earphone and the secondary earphone may know each other's address information. According to an embodiment, when a case is opened with the primary earphone and the secondary earphone inserted into the case, the primary earphone and the secondary earphone perform a page scan, and a second communication link may be established between the primary earphone and the secondary earphone.

In operation 903, the electronic device may transmit and/or receive audio data to and/or from the external electronic device through the first communication link. When a situation, such as making a call, receiving a call, or playing music, occurs, the electronic device may perform an operation of transmitting and/or receiving audio data to and/or from the external electronic device through the first communication link. The electronic device and the external electronic device may configure a CIS to transmit and/or receive audio data. The electronic device may isochronously transmit and/or receive sound data to and/or from the external electronic device through the CIS, and various parameters (ISO_Interval, Sub_Interval, SE_Length, Max_PDU, Max_SDU, MPTM, MPTS, NSE, BN, and/or FT) may be configured. The electronic device transmits CIS parameters to the external electronic device when a CIS connection is requested. The configuration of a CIS connection request packet is as follows.

CtrData

| | | | |
|---|---|---|---|
| LSB | | | |
| CIG_ID | CIS_ID | PHY_M_To_S | PHY_M_To_S |
| (1 octet) | (1 octet) | (1 octet) | (1 octet) |

CtrData(continued)

| | | | | |
|---|---|---|---|---|
| Max_SDU_M_To_S | RFU | Framed | Max_SDU_S_To_M | RFU |
| (12 bits) | (3 bits) | (1 bit) | (12 bits) | (4 bits) |

CtrData(continued)

| | | | |
|---|---|---|---|
| SDU_Interval_M_To_S | RFU | SDU_Interval_S_To_M | RFU |
| (20 bits) | (4 bits) | (20 bits) | (4 bits) |

CtrData(continued)

| | | | |
|---|---|---|---|
| Max_PDU_M_To_S | Max_PDU_S_To_M | NSE | Sub_Interval |
| (2 octets) | (2 octets) | (1 octet) | (3 octets) |

CtrData(continued)

| | | | | |
|---|---|---|---|---|
| BN_M_To_S | BN_S_To_M | FT_M_To_S | FT_S_To_M | ISO_Interval |
| (4 bits) | (4 bits) | (1 octet) | (1 octet) | (2 octets) |

CtrData(continued)

| | | |
|---|---|---|
| | | MSB |
| CIS_Offset_Min | CIS_Offset_Max | connEventCount |
| (3 octets) | (3 octets) | (2 octets) |

According to an embodiment, the electronic device may broadcast audio data via a broadcast isochronous stream (BIS) instead of establishing the first communication link (or CIS link) with the external electronic device. The BIS is a part of a broadcast isochronous group (BIG), and the BIG may include one or more BISs. For the BIG, various parameters (e.g., Num_BIS, ISO_Interval, BIS_Spacing, Sub_Interval, Max_PDU, Max_SDU, MTP, BN, PTO, IRC, and/or NSE) may be configured. The external electronic device may obtain BIGInfo (or BIG information) from ACAD of periodic advertising to receive the BIS. The external electronic device may identify a BIG operation mode through information included in the BIGInfo, and may receive the audio data via the BIS.

In operation 905, when the size of the audio data (or format of data) transmitted and/or received needs changing, the electronic device may derive a CIS configuration (e.g., an ISO interval, a subevent length (SE_Length), an subevent interval (Sub_Interval), and/or the number of subevents (NSE)) to be changed according to the size of the audio data (or format of data), and may transmit CIS configuration information to be changed to the external electronic device. According to an embodiment, the electronic device may determine that the size of the audio data to be transmitted and/or received needs changing when there is no audio data to be transmitted as in a mute configuration, when an audio codec being used is changed, or when an audio codec configuration is changed.

According to an embodiment, the electronic device may detect situations in which a characteristic of the audio data to be transmitted and/or received is changed and thus a CIS parameter needs changing, and may transmit a request to change the CIS parameter to be changed to the external electronic device. According to an embodiment, a CIS parameter change request packet may include one or more of ISO_Interval, Sub_Interval, SE_Length, Max_PDU, Max_SDU, MPTM, MPTs, NSE, BN, and/or FT as the parameter to be changed, and may include information about time at which an operation starts with the changed parameter.

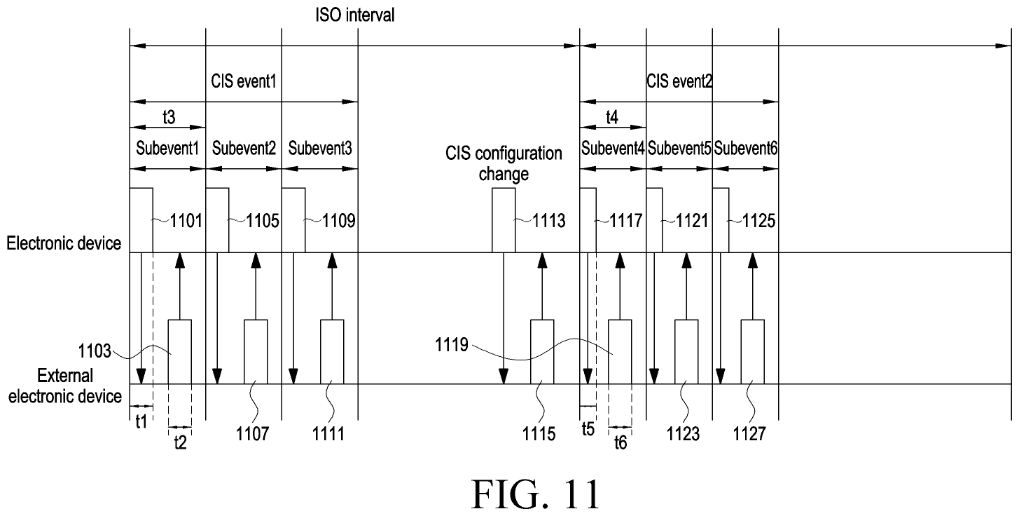

According to an embodiment, when the size of the audio data to be transmitted is reduced due to a change in the configuration of the audio codec, when the user configures a mute, or when there is no audio data to be transmitted for a certain time or longer, the electronic device may transmit a CIS configuration change request packet (e.g., a CIS configuration change of FIG. 11) for requesting a reduction in SE_Length and Sub_Interval according to the size of the audio data to the external electronic device. The CIS configuration change request packet may include information about time at which the changed configuration is applied.

According to an embodiment, the electronic device may detect situations in which a characteristic of the audio data to be broadcasted is changed and thus a BIG parameter needs changing, and may transmit a request to change the BIG parameter to be changed to the external electronic device. The request to change the BIG parameter may be broadcast using a BIG control packet, and may include at least one of Num_BIS, ISO_Interval, BIS_Spacing, Sub_Interval, Max_PDU, Max_SDU, MTP, BN, PTO, IRC, and/or NSE as the parameter to be changed. In the BIG, there is no acknowledgment protocol, but at least one of six consecutive BIS events needs to be received to maintain connection, and thus time to operate with the changed parameter may be configured to be after six periods.

In operation 907, the electronic device may identify whether an acceptance response to the CIS configuration information to be changed from the external electronic device is received. When the acceptance response from the external electronic device is received in operation 907 (Yes in 907), the electronic device may change the CIS configuration, based on the transmitted CIS configuration information in operation 909. In operation 911, the electronic device may transmit and/or receive the audio data to and/or from the external electronic device via the first communication link, based on the changed CIS configuration. As the electronic device changes the CIS configuration, based on the size or format of the audio data after the CIS link is established, the electronic device may efficiently transmit and/or receive the audio data even when the size or format of the audio data is dynamically changed. According to an embodiment, the electronic device may transmit and/or receive the audio data to and/or from the external electronic device with the changed CIS configuration from specified time (ISO interval).

According to an embodiment, when receiving the acceptance response to the CIS configuration change request packet from the external electronic device, the electronic device may change a CIS operation, based on the CIS parameter requested to be changed from change start time included in the CIS configuration change request packet. According to an embodiment, the change start time of the CIS operation may be immediately after receiving the response, or may be designated as specific time. For example, when SE_Length and Sub_Interval are short enough for the electronic device to additionally transmit and/or receive a subevent within the operating time of the existing CIS event, the electronic device may secure an additional transmission and/or reception occasion through a CIS configuration change of increasing an NSE value.

In an embodiment, the electronic device may change a BIG operation, based on the BIG parameter requested to be changed after the six periods. The electronic device may continue broadcasting the audio data with the BIG configuration changed using the existing BIG configuration.

When failing to receive the acceptance response from the external electronic device in operation 907 (No in 907), the electronic device may transmit and/or receive the audio data to and/or from the external electronic device, based on the existing (or unchanged) CIS configuration in operation 911. In addition, when failing to receive the acceptance response, the electronic device may retransmit the CIS configuration change request packet in the next ISO interval.

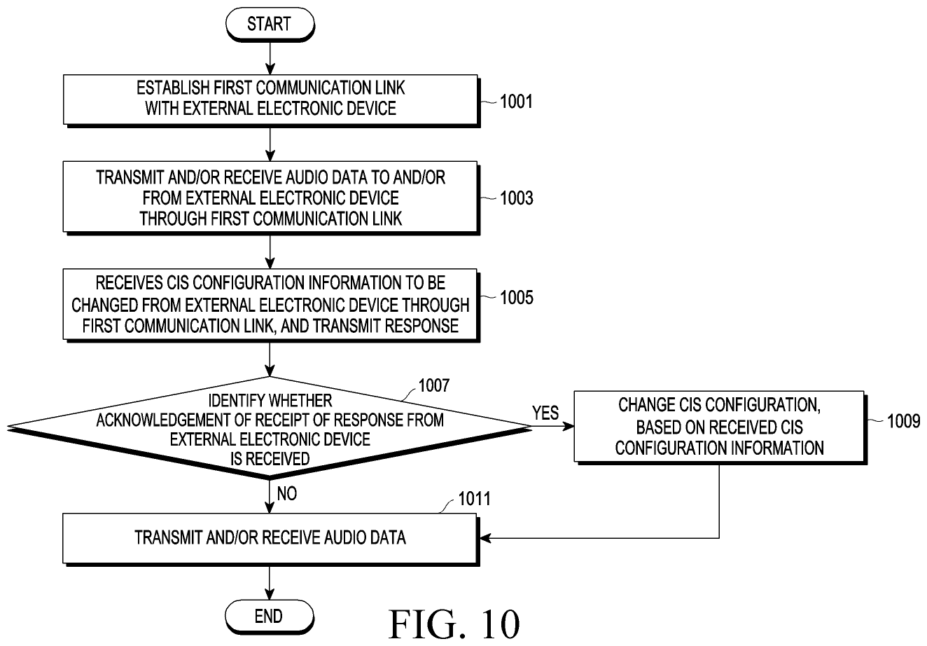

FIG. 10 is a flowchart illustrating an operating method of an electronic device receiving a configuration change request according to an embodiment of the disclosure.

In FIG. 10, the electronic device may transmit and/or receive audio data to and/or from an external electronic device through a CIS mode, and may receive a CIS configuration request from the external electronic device. For example, the electronic device may be configured as a wireless earphone, and the external electronic device may be configured as a terminal, a smartphone, a tablet personal computer (PC), a notebook computer, or a wearable device. In an embodiment, at least one of operation 1001 to operation 1011 may be omitted, some of the operations may be performed in a different order, or other operations may be added.

In operation 1001, the electronic device may establish a first communication link (or CIS link) with the external electronic device. In process 1003, the electronic device may transmit and/or receive audio data to and/or from the external electronic device through the first communication link. Operation 1001 and operation 1003 of FIG. 10 may be substantially the same as operation 901 and operation 903 of FIG. 9, respectively.

In operation 1005, the electronic device receives CIS configuration information (e.g., an ISO interval, a subevent length (SE_Length), a subevent interval (Sub_Interval), and/or the number of subevents (NSE)) to be changed from the external electronic device through the first communication link, and may transmit a response to the CIS configuration information to be changed to the external electronic device when determining to accept the CIS configuration information to be changed.

In an embodiment, the electronic device may configure a CIS to receive a CIS configuration change packet from the external electronic device with which the electronic device is communicating. According to an embodiment, when a requested CIS configuration change is possible, the electronic device may respond to the electronic device with acceptance of the CIS configuration change. According to an embodiment, when the electronic device is unable to change a CIS configuration, the electronic device may transmit a response of rejecting the CIS configuration change to the external electronic device. For example, the electronic device may receive a CIS configuration change packet for requesting a decrease in SE_Length and Sub_Interval for a specific transmission and/or reception interval from the external electronic device, and may transmit a response packet including acceptance or rejection of the request to the external electronic device.

According to an embodiment, the electronic device may receive a BIG control packet broadcast from the external electronic device through a BIS, and may identify a change in BIG parameter, based on the received BIG control packet. Since a BIG through a BIS has no acknowledgment protocol, a response of accepting or rejecting the change may not be made, and the electronic device may communicate using a changed parameter after preset time duration (e.g., six periods).

In operation 1007, the electronic device may identify whether the electronic device receives an acknowledgement of receipt of the response to the CIS configuration change from the external electronic device. When the acknowledgement of the receipt from the external electronic device is received in operation 1007 (Yes in 1007), the electronic device may change a CIS configuration, based on the CIS configuration information received from the external electronic device in operation 1009. When the electronic device receives the acknowledgement of the receipt from the external electronic device, the electronic device may recognize that the electronic device may transmit and/or receive audio data to and/or from the external electronic device according to the CIS configuration information received from the external electronic device. When recognizing that the electronic device may transmit and/or receive audio data to and/or from the external electronic device according to the CIS configuration information, the electronic device may change the CIS configuration, based on the CIS configuration information received from the external electronic device. In operation 1011, the electronic device may transmit and/or receive audio data to and/or from the external electronic device through the first communication link.

According to an embodiment, when receiving the acknowledgement of the receipt of the response to the CIS configuration change from the external electronic device, the electronic device may transmit and/or receive audio data to and/or from the external electronic device with the changed CIS configuration from a specified time (ISO interval) based on the CIS configuration information received from the external electronic device.

According to an embodiment, when receiving the acknowledgement of the receipt of the response to the CIS configuration change from the external electronic device, the electronic device may change the CIS configuration, based on the values of CIS parameters that need changing and information about time at which the change starts which are included in the received CIS configuration change packet. For example, when the electronic device is able to additionally transmit and/or receive a subevent within the existing CIS event operating time due to sufficiently short SE_Length and Sub_Interval as in the specific transmission and/or reception interval, the electronic device may accept a configuration change of increasing the value of NSE, thereby securing an additional transmission and/or reception opportunity. For example, when the first electronic device has difficulty in transmitting the subevent within the existing CIS event operating time due to long SE_Length and Sub_Interval as in the specific transmission and/or reception interval, the electronic device may accept a configuration change of reducing the value of NSE, thereby securing transmission and/or reception time.

According to an embodiment, the electronic device may change a BIG operation, based on a BIG parameter received via the BIG control packet after the six periods. The electronic device may continue receiving audio data broadcast by the external electronic device with a BIG configuration changed using the existing BIG configuration.

When railing to receive the acknowledgement of the receipt from the external electronic device in operation 1007 (No in 1007), the electronic device may transmit and/or receive audio data to and/or from the external electronic device, based on the existing (or unchanged) CIS configuration in operation 1111.

FIG. 11 illustrates an example of transmitting and/or receiving a packet between an electronic device and an external electronic device in a plurality of CIS events according to an embodiment of the disclosure.

Referring to FIG. 11, a first CIS event (CIS event 1) within an ISO interval includes a first subevent (subevent 1), a second subevent (subevent 2), and a third subevent (subevent 3). In the first subevent (subevent 1), the electronic device may transmit a 1-1 packet 1101 to the external electronic device, and the external electronic device may transmit a 1-2 packet 1103 to the electronic device. In the second subevent (subevent 2), the electronic device may transmit a 2-1 packet 1105 to the external electronic device, and the external electronic device may transmit a 2-2 packet 1107 to the electronic device. In the third subevent (subevent 3), the electronic device may transmit a 3-1 packet 1109 to the external electronic device, and the external electronic device may transmit a 3-2 packet 1111 to the electronic device. According to an embodiment, in the first CIS event (CIS event 1), a first time interval (t1) occupied by a packet transmitted from the electronic device to the external electronic device may be configured to be the same as a second time interval (t2) occupied by a packet transmitted from the external electronic device to the electronic device.

After the first CIS event, the electronic device may transmit a CIS configuration change request packet 1113 to the external electronic device when a data size change is required. When accepting a CIS parameter change included in the CIS configuration change request packet 1113, the external electronic device may transmit a response packet 1115 to the electronic device in response to the CIS configuration change request packet 1113. According to an embodiment, when successfully receiving the response packet 1115 in response to the CIS configuration change request packet 1113, the electronic device may transmit packets, based on a CIS parameter included in the CIS configuration change request packet 1113, from a second CIS event (CIS event 2) within the ISO interval.

The second CIS event (CIS event 2) within the ISO interval may include a fourth subevent (subevent 4), a fifth subevent (subevent 5), and a sixth subevent (subevent 6). In the fourth subevent (subevent 4), the electronic device may transmit a 4-1 packet 1117 to the external electronic device, based on changed (e.g., reduced) SE_Length (or Sub_Interval) (t4) included in the CIS configuration change request packet 1113, and the external electronic device may transmit a 4-2 packet 1119 to the electronic device. For example, Sub_Interval for each of the first subevent (subevent 1), the second subevent (subevent 2), and the third subevent (subevent 3) within the first CIS event (CIS event 1) may be t3, and Sub_Interval for the fourth subevent (subevent 4) within the second CIS event (CIS event 2) may be changed (or reduced) to t4.

In the fifth subevent (subevent 5), the electronic device may transmit a 5-1 packet 1121 to the external electronic device, based on changed (e.g., reduced) SE_Length or Sub_Interval included in the CIS configuration change request packet 1113, and the external electronic device may transmit a 5-2 packet 1123 to the electronic device. In the sixth subevent (subevent 6), the electronic device may transmit a 6-1 packet 1125 to the external electronic device, based on changed (e.g., reduced) SE_Length and Sub_Interval included in the CIS configuration change request packet 1113, and the external electronic device may transmit a 6-2 packet 1127 to the electronic device. For example, Sub_Interval for each of the first subevent (subevent 1), the second subevent (subevent 2), and the third subevent (subevent 3) within the first CIS event (CIS event 1) may be t3, and Sub_Interval for each of the fifth subevent (subevent 5) and the sixth subevent (subevent 6) within the second CIS event (CIS event 2) may be changed (or reduced) to t4.

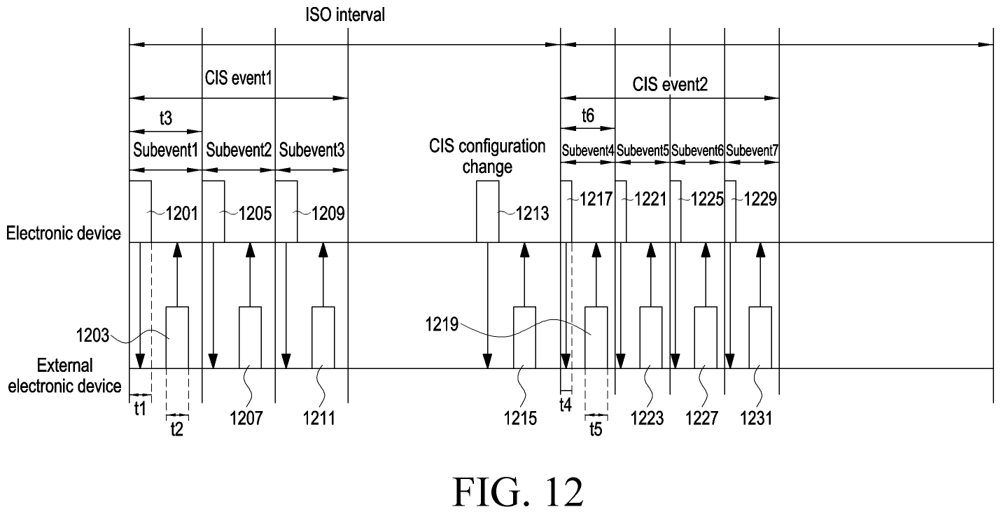

FIG. 12 illustrates another example of transmitting and/or receiving a packet between an electronic device and an external electronic device in a plurality of CIS events according to an embodiment of the disclosure.

Referring to FIG. 12, a first CIS event (CIS event 1) within an ISO interval may include a first subevent (subevent 1), a second subevent (subevent 2), and a third subevent (subevent 3). In the first subevent (subevent 1), the electronic device may transmit a 1-1 packet 1201 to the external electronic device, and the external electronic device may transmit a 1-2 packet 1203 to the electronic device. In the second subevent (subevent 2), the electronic device may transmit a 2-1 packet 1205 to the external electronic device, and the external electronic device may transmit a 2-2 packet 1207 to the electronic device. In the third subevent (subevent 3), the electronic device may transmit a 3-1 packet 1209 to the external electronic device, and the external electronic device may transmit a 3-2 packet 1211 to the electronic device. According to an embodiment, in a time interval (t3) occupied by the first subevent (subevent 1), a first time interval (t1) occupied by a packet transmitted from the electronic device to the external electronic device may be configured to be the same as a second time interval (t2) occupied by a packet transmitted from the external electronic device to the electronic device.

After the first CIS event (CIS event 1), the electronic device may transmit a CIS configuration change request packet 1213 to the external electronic device when a data size change is required. When accepting a CIS parameter change included in the CIS configuration change request packet 1213, the external electronic device may transmit a response packet 1215 to the electronic device in response to the CIS configuration change request packet 1213. According to an embodiment, when successfully receiving the response packet 1215 in response to the CIS configuration change request packet 1213, the electronic device may transmit packets, based on a CIS parameter included in the CIS configuration change request packet 1213, from a second CIS event (CIS event 2) within the ISO interval.

The second CIS event (CIS event 2) within the ISO interval may include a fourth subevent (subevent 4), a fifth subevent (subevent 5), a sixth subevent (subevent 6), and a seventh subevent (subevent 7). In the fourth subevent (subevent 4), the electronic device may transmit a 4-1 packet 1217 to the external electronic device by reducing SE_Length and Sub_Interval, based on changed (e.g., reduced) SE_Length and Sub_Interval values included in the CIS configuration change request packet 1213, and the external electronic device may transmit a 4-2 packet 1219 to the electronic device.

In the fifth subevent (subevent 5), the electronic device may transmit a 5-1 packet 1221 to the external electronic device by reducing SE_Length and Sub_Interval, based on the changed (e.g., reduced) SE_Length and Sub_Interval values included in the CIS configuration change request packet 1213, and the external electronic device may transmit a 5-2 packet 1223 to the electronic device. In the sixth subevent (subevent 6), the electronic device may transmit a 6-1 packet 1225 to the external electronic device by reducing SE_Length and Sub_Interval, based on changed (e.g., reduced) SE_Length and Sub_Interval values included in the CIS configuration change request packet 1213, and the external electronic device may transmit a 6-2 packet 1227 to the electronic device. The electronic device may add a subevent by increasing NSE by 1 based on an NSE value included in the CIS configuration change request packet 1213. In the seventh subevent (subevent 7) secured by reducing SE_Length and Sub_Interval in the preceding fourth, fifth, and sixth subevents, the electronic device may transmit a 7-1 packet 1229 to the external electronic device by configuring SE_Length and Sub_Interval, based on the changed (e.g., reduced) SE_Length and Sub_Interval values included in the CIS configuration change request packet 1213 to transmit the, and the external electronic device may transmit a 7-2 packet 1231 to the electronic device.

According to an embodiment, when determining that SE_Length and Sub_Interval for data to be transmitted are short enough to transmit and/or receive an additional subevent within a CIS event, the electronic device may transmit a request for a CIS configuration change of reducing the SE_Length and Sub_Interval values and increasing the NSE value to the external electronic device.

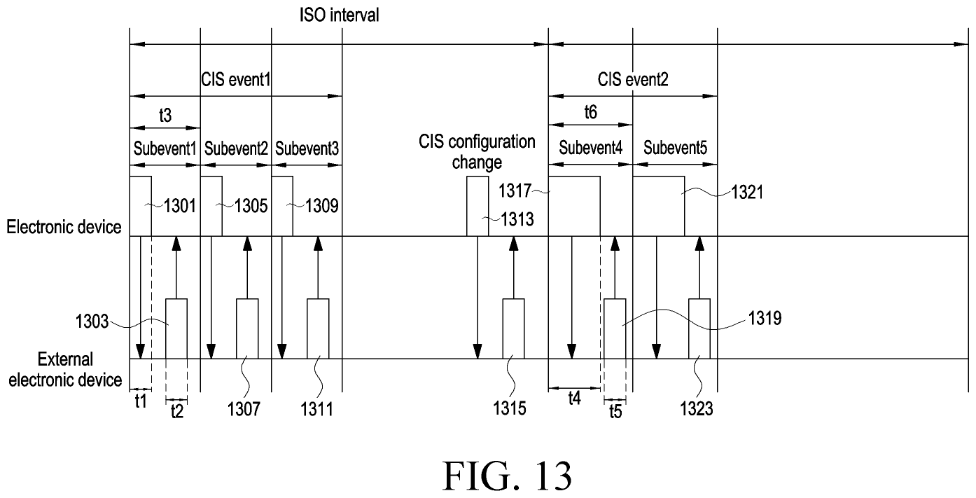

FIG. 13 illustrates still another example of transmitting and/or receiving a packet between an electronic device and an external electronic device in a plurality of CIS events according to an embodiment of the disclosure.

Referring to FIG. 13, a first CIS event (CIS event 1) within an ISO interval may include a first subevent (subevent 1), a second subevent (subevent 2), and a third subevent (subevent 3). In the first subevent (subevent 1), the electronic device may transmit a 1-1 packet 1301 to the external electronic device, and the external electronic device may transmit a 1-2 packet 1303 to the electronic device. According to an embodiment, in a time interval (t3) occupied by the first subevent (subevent 1), a first time interval (t1) occupied by a packet transmitted from the electronic device to the external electronic device may be configured to be the same as a second time interval (t2) occupied by a packet transmitted from the external electronic device to the electronic device. In the second subevent (subevent 2), the electronic device may transmit a 2-1 packet 1305 to the external electronic device, and the external electronic device may transmit a 2-2 packet 1307 to the electronic device. In the third subevent (subevent 3), the electronic device may transmit a 3-1 packet 1309 to the external electronic device, and the external electronic device may transmit a 3-2 packet 1311 to the electronic device. According to an embodiment, in the first CIS event (CIS event1), the first time interval occupied by the packet transmitted from the electronic device to the external electronic device may be configured to be the same as a second time interval occupied by the packet transmitted from the external electronic device to the electronic device.

After the first CIS event, the electronic device may transmit a CIS configuration change request packet 1313 to the external electronic device when a data size change is required. When accepting a CIS parameter change included in the CIS configuration change request packet 1313, the external electronic device may transmit a response packet 1315 to the electronic device in response to the CIS configuration change request packet 1313. According to an embodiment, when successfully receiving the response packet 1315 in response to the CIS configuration change request packet 1313, the electronic device may transmit packets, based on a CIS parameter included in the CIS configuration change request packet 1313, from a second CIS event (CIS event 2) within the ISO interval.

The second CIS event (CIS event 2) within the ISO interval may include a fourth subevent (subevent 4) and a fifth subevent (subevent 5). In the fourth subevent (subevent 4), the electronic device may transmit a 4-1 packet 1317 to the external electronic device by increasing SE_Length and Sub_Interval, based on changed (e.g., reduced) SE_Length and Sub_Interval values included in the CIS configuration change request packet 1313, and the external electronic device may transmit a 4-2 packet 1319 to the electronic device. In the fifth subevent (subevent 5), the electronic device may transmit a 5-1 packet 1321 to the external electronic device by increasing SE_Length and Sub_Interval, based on the changed (e.g., reduced) SE_Length and Sub_Interval values included in the CIS configuration change request packet 1313, and the external electronic device may transmit a 5-2 packet 1323 to the electronic device. The electronic device may remove a third subevent by reducing NSE by 1, based on an NSE value included in the CIS configuration change request packet. According to an embodiment, in a time interval (t6) occupied by the fourth subevent (subevent 4), a third time interval (t4) occupied by a packet transmitted from the electronic device to the external electronic device may be configured to be shorter than a fourth time interval (t5) occupied by a packet transmitted from the external electronic device to the electronic device.

According to an embodiment, when determining that SE_Length and Sub_Interval for data to be transmitted are too long to transmit data within a preset subevent in a CIS event, the electronic device may transmit a request for a CIS configuration change of increasing the SE_Length and Sub_Interval values and increasing the NSE value to the external electronic device.

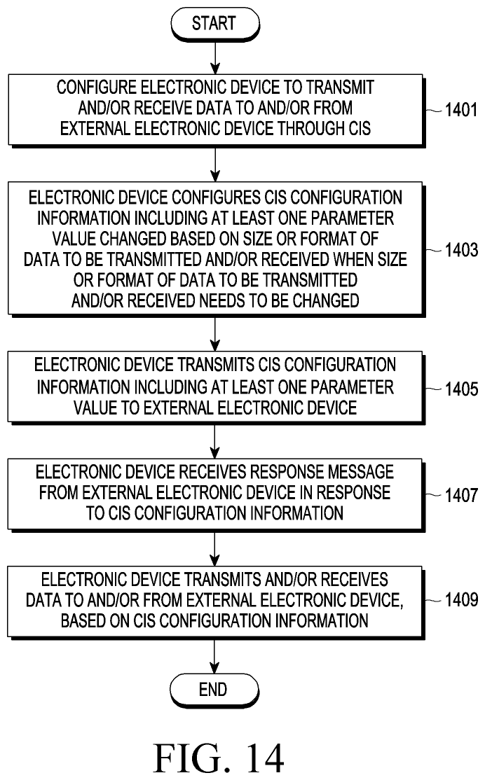

FIG. 14 is a flowchart illustrating an operating method of an electronic device according to an embodiment of the disclosure.

Referring to FIG. 14, in operation 1401, the electronic device (e.g., 101 of FIG. 1 and 300 of FIG. 3) may be configured to transmit and/or receive data to and/or from an external electronic device (e.g., 101 of FIGS. 1, 310 and 311 of FIGS. 3, 320 and 321 of FIG. 3, and 330 and 331 of FIG. 3) via a CIS. According to an embodiment, the electronic device may establish a communication link for a CIS with the external electronic device, and may transmit and/or receive data, based on the established communication link. According to an embodiment, the electronic device may receive an advertising message from the external electronic device. According to an embodiment, the electronic device may establish the communication link for the CIS with the external electronic device by using information included in the advertising message.

In operation 1403, when the size or format of the data to be transmitted and/or received needs to be changed, the electronic device may configure CIS configuration information including at least one parameter value changed based on the size or format of the data to be transmitted and/or received. According to an embodiment, the electronic device may change at least one parameter value for the CIS, based on the size or format of the data to be transmitted and/or received. According to an embodiment, the at least one parameter value may be at least one of an ISO interval, a subevent length (SE_Length), a subevent interval (Sub_Interval), and the number of subevents (NSE).

In operation 1405, the electronic device may transmit the CIS configuration information including the at least one parameter value to the external electronic device. In operation 1407, the electronic device may receive a response message from the external electronic device in response to the CIS configuration information. According to an embodiment, the response message may be an acceptance message of the external electronic device with respect to the configuration information including the at least one parameter value or a rejection message of the external electronic device with respect to the configuration information including the at least one parameter value.

In operation 1409, the electronic device may transmit and/or receive data to and/or from the external electronic device, based on the CIS configuration information. According to an embodiment, the electronic device and the external electronic device may transmit and/or receive the data by using the at least one parameter value included in the CIS configuration information.

According to an embodiment, an electronic device (101 of FIG. 1 or 300 of FIG. 3) may include a communication circuit (190 of FIG. 1) and at least one processor (120 of FIG. 1) operatively connected, directly or indirectly, to the communication circuit (190 of FIG. 1). The at least one processor (120 of FIG. 1) may configure the electronic device (101 of FIG. 1 or 300 of FIG. 3) to transmit and/or receive data to and/or from an external electronic device through a connected isochronous stream (CIS) mode, and may configure CIS configuration information including at least one parameter value changed based on a size or format of the data to be transmitted and/or received when the size or format of the data to be transmitted and/or received needs to be changed. The at least one processor (120 of FIG. 1) may perform control to transmit the CIS configuration information including the at least one parameter value to the external electronic device through the communication circuit (190 of FIG. 1). The at least one processor (120 of FIG. 1) may receive a response message from the external electronic device in response to the CIS configuration information through the communication circuit (190 of FIG. 1). The at least one processor (120 of FIG. 1) may transmit and/or receive the data to and/or from the external electronic device, based on the CIS configuration information.

According to an embodiment, the at least one processor (120 of FIG. 1) may receive an advertising message from the external electronic device through the communication circuit (190 of FIG. 1). The at least one processor (120 of FIG. 1) may establish a CIS link with the external electronic device by using information included in the advertising message.

According to an embodiment, the at least one parameter value changed based on the size or format of the data to be transmitted and/received may be at least one of an ISO interval, a subevent length (SE_Length), a subevent interval (Sub_Interval) and a number of subevents (NSE).

According to an embodiment, the response message may be an acceptance message of the external electronic device with respect to the configuration information including the at least one parameter value or a rejection message of the external electronic device with respect to the configuration information including the at least one parameter value.

According to an embodiment, the at least one processor (120 of FIG. 1) may determine that the size of the format of the data to be transmitted and/or received needs to be changed when there is no audio data to be transmitted in at least one CIS subevent due to a mute configuration. According to an embodiment, the at least one processor (120 of FIG. 1) may determine that the size of the format of the data to be transmitted and/or received needs to be changed when a used audio codec is changed. According to an embodiment, the at least one processor (120 of FIG. 1) may determine that the size of the format of the data to be transmitted and/or received needs to be changed when a configuration of the audio codec is changed.

According to an embodiment, the CIS configuration information including the at least one parameter value may include information about time to apply the at least one parameter value.

According to an embodiment, an electronic device (101 of FIGS. 1, 310 and 311 of FIGS. 3, 320 and 321 of FIG. 3, or 330 and 331 of FIG. 3) may include a communication circuit (190 of FIG. 1) and at least one processor (120 of FIG. 1) operatively connected to the communication circuit (190 of FIG. 1). The at least one processor (120 of FIG. 1) may receive CIS configuration information including at least one parameter value changed based on a size or format of data to be transmitted and/or received from an external electronic device through the communication circuit (190 of FIG. 1) when the electronic device (101 of FIGS. 1, 310 and 311 of FIGS. 3, 320 and 321 of FIG. 3, or 330 and 331 of FIG. 3) is configured to transmit and/or receive data to and/or from the external electronic device through a connected isochronous stream (CIS) mode. The at least one processor (120 of FIG. 1) may perform control to transmit a response message to the external electronic device in response to the CIS configuration information through the communication circuit (190 of FIG. 1). The at least one processor (120 of FIG. 1) may transmit and/or receive the data to and/or from the external electronic device, based on the CIS configuration information.

According to an embodiment, the at least one processor (120 of FIG. 1) may perform control to transmit an advertising message to the external electronic device through the communication circuit (190 of FIG. 1). According to an embodiment, the at least one processor (120 of FIG. 1) may establish a CIS link with the electronic device by using information included in the advertising message.

According to an embodiment, the at least one parameter value changed based on the size or format of the data to be transmitted and/received may be at least one of an ISO interval, a subevent length (SE_Length), a subevent interval (Sub_Interval) and a number of subevents (NSE). According to an embodiment, the response message may be an acceptance message of the electronic device with respect to the configuration information including the at least one parameter value or a rejection message of the electronic device with respect to the configuration information including the at least one parameter value.

According to an embodiment, a method of an electronic device (101 of FIG. 1 or 300 of FIG. 3) may configure the electronic device to transmit and/or receive data to and/or from an external electronic device through a connected isochronous stream (CIS). The method of the electronic device may include configuring CIS configuration information including at least one parameter value changed based on a size or format of the data to be transmitted and/or received when the size or format of the data to be transmitted and/or received needs to be changed. The method of the electronic device may include transmitting the CIS configuration information including the at least one parameter value to the external electronic device. The method of the electronic device may include receiving a response message from the external electronic device in response to the CIS configuration information. The method of the electronic device may include transmitting and/or receiving the data to and/or from the external electronic device, based on the CIS configuration information.

According to an embodiment, a method of an electronic device (101 of FIGS. 1, 310 and 311 of FIGS. 3, 320 and 321 of FIG. 3, or 330 and 331 of FIG. 3) may include receiving CIS configuration information including at least one parameter value changed based on a size or format of data to be transmitted and/or received from an external electronic device when the electronic device is configured to transmit and/or receive data to and/or from the external electronic device through a connected isochronous stream (CIS). The method of the electronic device may include transmitting a response message to the external electronic device in response to the CIS configuration information. The method of the electronic device may include transmitting and/or receiving the data to and/or from the external electronic device, based on the CIS configuration information.

According to an embodiment, there may be provided a storage medium storing at least one computer-readable instruction. The at least one instruction may, when executed by the at least one processor, cause an electronic device (101 of FIG. 1 or 300 of FIG. 3) to perform a plurality of operations. The plurality of operations may include configuring CIS configuration information including at least one parameter value changed based on a size or format of the data to be transmitted and/or received when the electronic device is configured to transmit and/or receive data to and/or from an external electronic device through a connected isochronous stream (CIS) and the size or format of the data to be transmitted and/or received needs to be changed. The plurality of operations may include transmitting the CIS configuration information including the at least one parameter value to the external electronic device. The plurality of operations may include receiving a response message from the external electronic device in response to the CIS configuration information. The plurality of operations may include transmitting and/or receiving the data to and/or from the external electronic device, based on the CIS configuration information. “Based on” as used herein covers based at least on.

According to an embodiment, there may be provided a storage medium storing at least one computer-readable instruction. The at least one instruction may, when executed by the at least one processor, cause an electronic device (101 of FIGS. 1, 310 and 311 of FIGS. 3, 320 and 321 of FIG. 3, or 330 and 331 of FIG. 3) to perform a plurality of operations. The plurality of operations may include receiving CIS configuration information including at least one parameter value changed based on a size or format of data to be transmitted and/or received from an external electronic device when the electronic device is configured to transmit and/or receive data to and/or from the external electronic device through a connected isochronous stream (CIS). The plurality of operations may include transmitting a response message to the external electronic device in response to the CIS configuration information. The plurality of operations may include transmitting and/or receiving the data to and/or from the external electronic device, based on the CIS configuration information.

While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

1. An electronic device comprising:
memory storing instructions;
a communication circuit; and
at least one processor, comprising processing circuitry, operatively connected to the communication circuit and the memory,
wherein the instructions that, when executed by the at least one processor individually and/or collectively, cause the electronic device to:
transmit and/or receive data to and/or from an external electronic device through a connected isochronous stream (CIS);
configure CIS configuration information comprising at least one parameter value changed based on a size and/or format of the data to be transmitted and/or received when the size and/or format of the data to be transmitted and/or received is to be changed;
transmit the CIS configuration information comprising the at least one parameter value to the external electronic device through at least the communication circuit;
receive a response message from the external electronic device in response to the CIS configuration information through the communication circuit; and
transmit and/or receive the data to and/or from the external electronic device, based on the CIS configuration information.

2. The electronic device of claim 1, wherein the instructions that, when executed by the at least one processor individually and/or collectively, cause the electronic device to:
receive an advertising message from the external electronic device through the communication circuit; and
establish a CIS link with the external electronic device using information included in the advertising message.

3. The electronic device of claim 1, wherein the at least one parameter value changed based on the size and/or format of the data to be transmitted and/received is at least one of: an ISO interval, a subevent length (SE_Length), a subevent interval (Sub_Interval) and a number of subevents (NSE).

4. The electronic device of claim 1, wherein the response message is:
an acceptance message from the external electronic device with respect to the configuration information comprising the at least one parameter value; and/or
a rejection message from the external electronic device with respect to the configuration information comprising the at least one parameter value.

5. The electronic device of claim 1, wherein the instructions that, when executed by the at least one processor individually and/or collectively, cause the electronic device to:
determine that the size and/or format of the data to be transmitted and/or received needs to be changed when there is no audio data to be transmitted in at least one CIS subevent due to a mute configuration;
determine that the size and/or format of the data to be transmitted and/or received needs to be changed when a used audio codec is changed; and/or
determine that the size and/or format of the data to be transmitted and/or received needs to be changed when a configuration of the audio codec is changed.

6. The electronic device of claim 1, wherein the CIS configuration information comprising the at least one parameter value comprises information about time to apply the at least one parameter value.

7. An electronic device comprising:
memory storing instructions;
a communication circuit; and
at least one processor, comprising processing circuitry, operatively connected to the communication circuit and the memory,
wherein the instructions that, when executed by the at least one processor individually and/or collectively, cause the electronic device to:
receive CIS configuration information comprising at least one parameter value changed based on a size and/or format of data to be transmitted and/or received from an external electronic device through the communication circuit when the electronic device is configured to transmit and/or receive data to and/or from the external electronic device through a connected isochronous stream (CIS) mode;
transmit a response message to the external electronic device in response to the CIS configuration information through the communication circuit; and
transmit and/or receive the data to and/or from the external electronic device, based on the CIS configuration information.

8. The electronic device of claim 7, wherein the instructions that, when executed by the at least one processor individually and/or collectively, cause the electronic device to:
transmit an advertising message to the external electronic device through the communication circuit; and
establish a CIS link with the electronic device by using information included in the advertising message.

9. The electronic device of claim 7, wherein the at least one parameter value changed based on the size and/or format of the data to be transmitted and/received is at least one of an ISO interval, a subevent length (SE_Length), a subevent interval (Sub_Interval) and a number of subevents (NSE).

10. The electronic device of claim 7, wherein the response message is:
an acceptance message from the electronic device with respect to the configuration information comprising the at least one parameter value; and/or
a rejection message from the electronic device with respect to the configuration information comprising the at least one parameter value.

11. A method of an electronic device, the method comprising:
the electronic device transmitting and/or receiving data to and/or from an external electronic device through a connected isochronous stream (CIS);
configuring CIS configuration information comprising at least one parameter value changed based on a size and/or format of the data to be transmitted and/or received when the size and/or format of the data to be transmitted and/or received is to be changed;
transmitting the CIS configuration information comprising the at least one parameter value to the external electronic device;
receiving a response message from the external electronic device in response to the CIS configuration information; and
transmitting and/or receiving the data to and/or from the external electronic device, based on the CIS configuration information.

12. The method of claim 11, further comprising:
receiving an advertising message from the external electronic device; and
establishing a CIS link with the external electronic device using information included in the advertising message.

13. The method of claim 11, wherein the at least one parameter value changed based on the size and/or format of the data to be transmitted and/received is at least one of an ISO interval, a subevent length (SE_Length), a subevent interval (Sub_Interval) and a number of subevents (NSE).

14-15. (canceled)

16. The method of claim 11, wherein the response message is:
an acceptance message from the external electronic device with respect to the configuration information comprising the at least one parameter value; and/or
a rejection message from the external electronic device with respect to the configuration information comprising the at least one parameter value.

17. The method of claim 11, further comprising:
determining that the size and/or format of the data to be transmitted and/or received needs to be changed when there is no audio data to be transmitted in at least one CIS subevent due to a mute configuration;
determining that the size and/or format of the data to be transmitted and/or received needs to be changed when a used audio codec is changed; and/or
determining that the size and/or format of the data to be transmitted and/or received needs to be changed when a configuration of the audio codec is changed.

18. The method of claim 11, wherein the CIS configuration information comprising the at least one parameter value comprises information about time to apply the at least one parameter value.
